(19) United States
(12) Patent Application Publication
(10) Pub. No.: US 2015/0211291 A1
(43) Pub. Date: Jul. 30, 2015

(54) FINGER PROTECTION DEVICE

(71) Applicant: Thomas A. Jaffee, Boca Raton, FL (US)

(72) Inventor: Thomas A. Jaffee, Boca Raton, FL (US)

(73) Assignee: Thomas A. Jaffee, Boca Raton, FL (US)

(21) Appl. No.: 14/168,504

(22) Filed: Jan. 30, 2014

(51) Int. Cl. E06B 7/36

(52) U.S. Cl. CPC E06B 7/367

(57) ABSTRACT

A finger protection device for protecting the fingers of a person from getting impinged in the space created in between the hinged door and the doorframe is provided. The finger protection device is mounted on the hinge-side of a door. The finger protection device includes five elongated segments sequentially pivotally attached to one another along their long edges. The first elongated segment is attached to the inner edge of the doorframe and the fifth elongated segment is attached to the edge of the door. The length in combination of the first elongated segment and the second elongated segment is configured to match the length in combination of the third elongated segment and the fourth elongated segment, so as to force each of the elongated segments to fold until they lie flat against one another and further lie flat against the front face of the door, when the door is closed.

### BACKGROUND OF THE INVENTION

1. Field of the Invention

The present invention generally relates to a finger protection device, and more particularly relates to the finger protection device that covers the hinge-side space of an open hinged door, and when the door is dosed, the device folds until its segments He flat against one another and further he flat against the front face of the door.

2. Description of Related Art

Door safety relates to prevention of door-related accidents. Such accidents take place in various forms, and in a number of locations such as car doors, garage doors and hinged doors. According to the National Safety Council, in the United States, approximately 300,000 injuries, including serious injuries to fingers, are caused by doors every year. A closing door can exert up to 40 tons per square inch of pressure between the hinges. Because of the number of accidents taking place, there has been a surge in the number of lawsuits. Thus, organizations may be at risk when car doors or doors within buildings lack safety devices that can help prevent injuries.

According to the US General Services Administration: “It is essential that children's fingers be protected from being crushed or otherwise injured in the hinge space of a swinging door or gate. There are simple devices available to attach to the hinge side, ensuring that this type of injury does not occur. As the door closes, the hand is pushed out of the opening, away from harm. In addition, young children are vulnerable to injury when they fall against the other (hinged) side of doors and gates, striking projected hinges. Piano hinges are not recommended to alleviate this problem as they tend to sag over time with heavy use. Instead, an inexpensive device fitting over hinges is available on the market and should be used to ensure safety . . . ”

Finger protection devices are used to prevent injury to body parts that get impinged in between the the gap created by a hinged door and doorframe. These products prevent injury by holding doors in fully or partially open positions. An example of such device is a flexible membrane that covers the gap between door hinge and the doorframe preventing fingers from being inserted into the hinge-side gap; another example of such device is a wedge device for hanging on a door hinge, which is connected to a door and to a doorframe, and prevents the door from being closed.

However, most devices that cover the hinge-side gap are attached to the outside of the door and the doorframe, often require attachment with screws that damage the visible surface after the device is removed, often are bulky and made of an opaque material that can detract from the aesthetics of a home or commercial building. The devices that hang from the door hinge keep the door in its open position and must be removed in order to close the door, at which point the door no longer has a safety device until someone remembers to put it on each time the door is reopened.

Therefore, there is a need for a finger protection device that covers the hinge-side gaps when the door is opened, and is foldable until they lie flat against one another and further lie flat against the front face of the door.

### SUMMARY OF THE INVENTION

In accordance with the teachings of the present invention, a finger protection device configured to be mounted in between the hinged door and the doorframe is provided.

An object of the present invention is to provide a finger protection device mounted on the hinge-side of the door for covering the space created in between the door and the doorframe, when the hinged door is opened. The finger protection device includes five elongated segments sequentially pivotally attached to one another along their long edges. The first elongated segment attached to the edge of the hinged door and the fifth elongated segment attached to the doorframe.

The length of the combined first elongated segment and the second elongated segment is configured to match the length of the combined third elongated segment and the fourth elongated segment, so as to force each of the elongated segments to fold until they lie flat against one another and further lie against the front face of the hinged door, when the hinged door is closed.

Another object of the present invention is to provide attachment means for attaching the first elongated segment with the edge of the hinged door and the fifth elongated segment with the doorframe on the inner edge of the doorframe. The attachment means include but not limited to velcro, adhesives, screws, nails, and the like.

Another object of the present invention is to provide a sixth elongated segment sequentially pivotally attached to the first elongated segment from the long edges, further the sixth elongated segment is mounted on the inner surface of the doorframe for providing stability to the remaining elongated segments when the hinged door is opened.

Another object of the present invention is to make the five elongated segments with either rubber, plastic, polymer, thermoplastic polymer or elastomer etc. Further, the five elongated segments are made transparent to decrease their visibility.

Further features and advantages of the present invention, as well as the structure and operation of various embodiments of the present invention, are described in detail below with reference to the accompanying drawings.

### BRIEF DESCRIPTION OF THE DRAWINGS

FIG. 1 illustrates a top view of a finger protection device when the hinged door is opened, in accordance with a preferred embodiment of the present invention;

FIG. 2 illustrates a flat view of a finger protection device in accordance with a preferred embodiment of the present invention;

FIG. 3 illustrates a top perspective view of the finger protection device mounted on the closed hinged door in accordance with a preferred embodiment of the present invention; and

FIG. 4 illustrates a top perspective of the finger protection device mounted on an open door, having attachment unit in accordance with a preferred embodiment of the present invention.

### DETAILED DESCRIPTION OF DRAWINGS

While this technology is illustrated and described in a preferred embodiment, a finger protection device may be produced in many different configurations, forms, and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

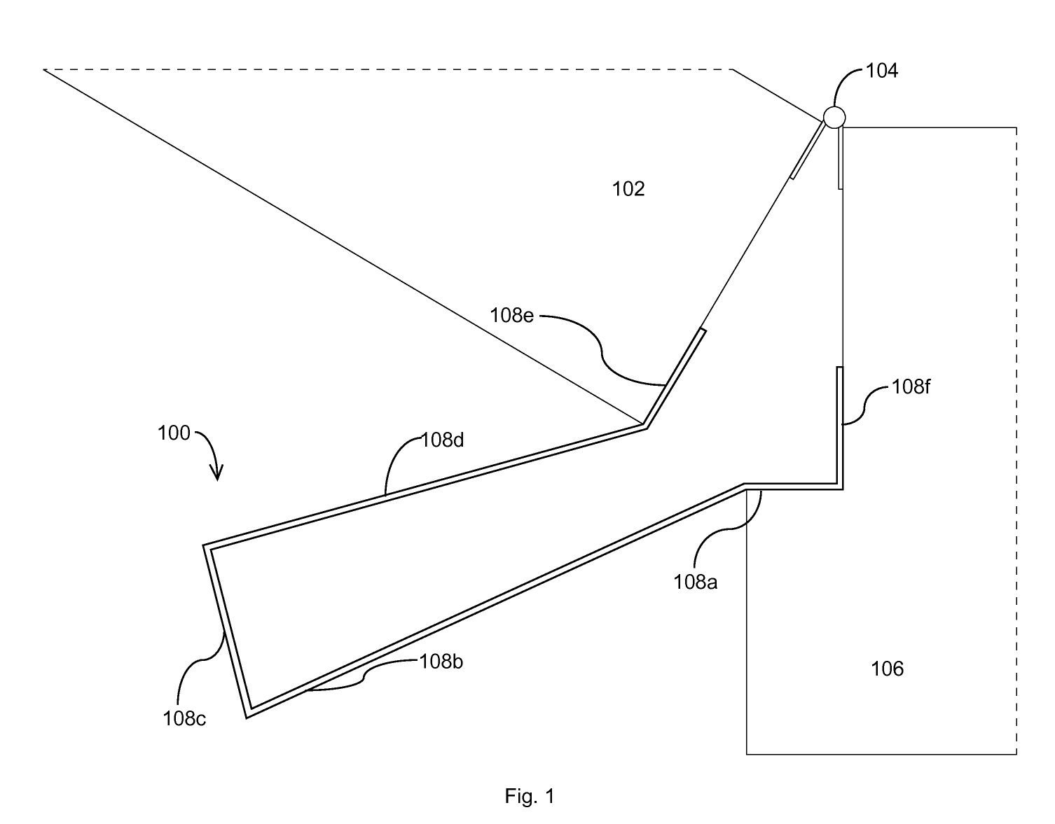

FIG. 1 illustrates a top view of a finger protection device 100 when the hinged door 102 is opened. The finger protection device 100 is configured to be mounted on the hinge-side 104 of a hinged door 102 for covering the space created in between the hinged door 102 and the doorframe 106. The finger protection device 100 includes five elongated segments 108 such as first elongated segment 108a, second elongated segment 108b, third elongated segment 108c, fourth elongated segment 108d and fifth elongated segment 108e, sequentially, pivotally attached to one another along their long edges.

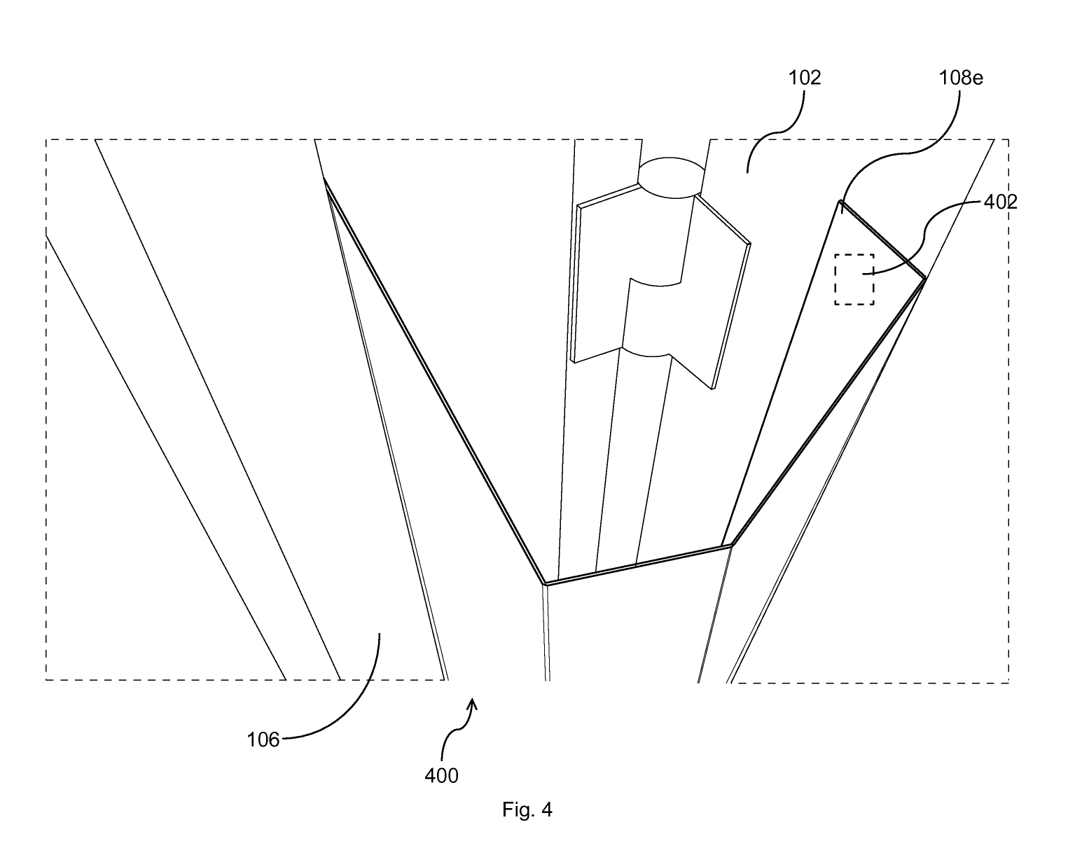

In a preferred embodiment of the present invention, the first elongated segment 108a is attached on the inner edge of the doorframe 106 and the fifth elongated segment 108e is attached to the edge of the hinged door 102. The attachment of the first elongated segment 108a on the doorframe 106 and the fifth elongated segment 108e on the hinged door 102 is shown and explained in detailed in conjunction with FIG. 4 of the present invention.

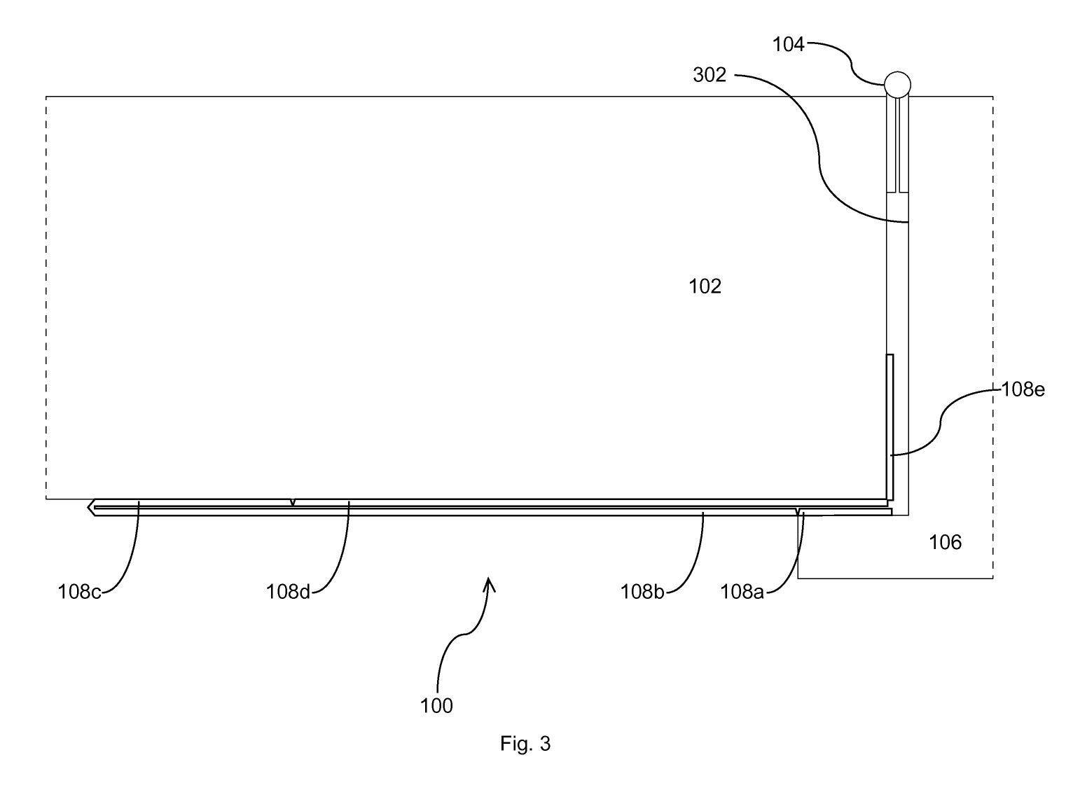

The length of the combined first elongated segment 108a and second elongated segment 108b is configured to match the length of the combined third elongated segment 108c and fourth elongated segment 108d, so as to force each of the elongated segments 108 to fold until they lie flat against one another and further lie flat against the front face of the hinged door, when the hinged door 102 is closed. The position of the finger protection device 100 on the closed hinged door 102 is explained in detail in conjunction with FIG. 3 of the present invention.

In another embodiment of the present invention, the finger protection device 100 further includes a sixth elongated segment 108f sequentially pivotally attached to the first elongated segment 108a from the long edges, further the sixth elongated segment 108f is mounted on the inner surface of the doorframe 106 for providing stability to the remaining elongated segments 108 when the hinged door 102 is opened.

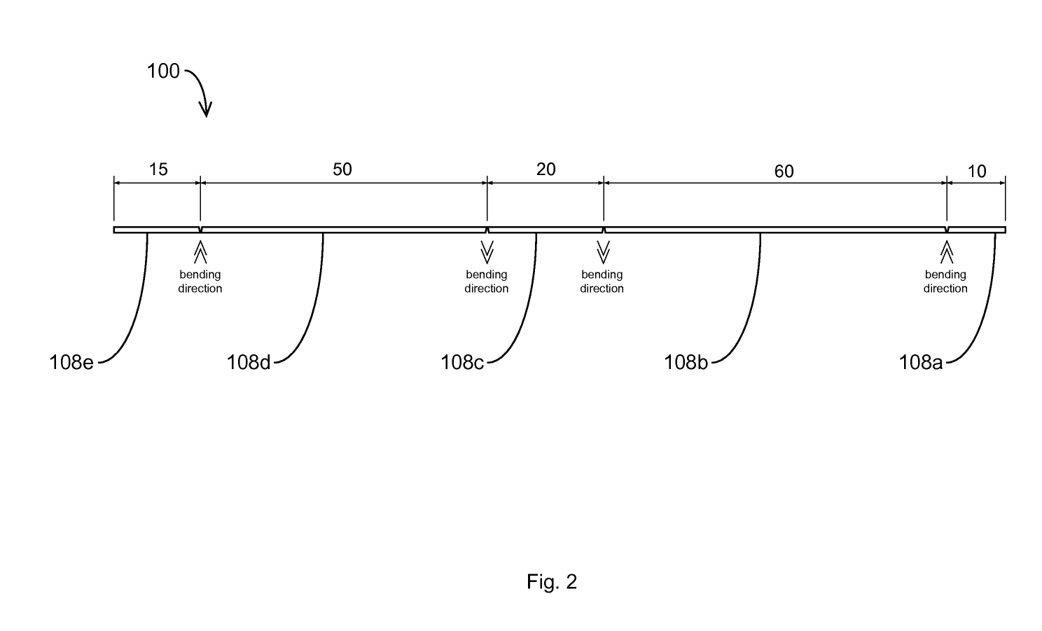

FIG. 2 illustrates a flat view of the finger protection device 100 in accordance with a preferred embodiment of the present invention. In a preferred embodiment of the present invention, the length of first elongated segment 108a is 10 mm, second elongated segment 108b is 60 mm, third elongated segment 108c is 20 mm, fourth elongated segment 108d is 50 mm and the fifth elongated segment 108e is 15 mm. The folding of each elongated segment 108 is done in a way so that on application of force all of them lie against one another on the front face of the hinged door.

In a preferred embodiment of the present invention, the bending directions in between the elongated segments is a necessary aspect of the functionality of the device. Assuming two bending directions, up or down, about which the adjoining segments can rotate about their adjoining axis, the elongated segments rotate as follows: Fifth elongated segment 108e and fourth elongated segment 108d rotate in the upward direction about adjoining long edge; third elongated segment 108c and fourth elongated segment 108d rotate about their mutual axis in the downward direction; second elongated segment 108b and third elongated segment 108c rotate about their mutual axis in the downward direction; first elongated segment 108a and second elongated segment 108b rotate about their mutual axis in the upward direction.

However it will be readily apparent to those skilled in the art that the dimensions of the elongated segments 108 may vary according to the hinged door and the door frame size, as well as the maximum opening angle of the door, without deviating from the scope of the present invention. Further, the folding of elongated segments is to facilitate the bending and allowing them to fold against each other on the face of the hinged door as the door is closed, or away from each other as the hinged door is opened.

FIG. 3 illustrates a top view of the finger protection device 100 when the hinged door 102 is closed in accordance with a preferred embodiment of the present invention. The first elongated segment 108a is attached to the doorframe 106 at its inner edge 302. When the hinged door 102 is closed, the first elongated segment 108a and the second elongated segment 108b lies parallel on the third elongated segment 108c and the fourth elongated segment 108d. The length of the second elongated segment 108b forces the third elongated segment 108c and the fourth elongated segment 108d to fold and lie against one another against the face of the closed hinged door 102.

In a preferred embodiment of the present invention, the elongated segments 108 are made up of either rubber, plastic, polymer, metal, elastomer or thermoplastic elastomer. However, it will be readily apparent to those skilled in the art that various other materials may also be used for creating the elongated segments 108 without deviating from the scope of the present invention. Further, in a preferred embodiment, the elongated segments 108 are kept transparent to decrease their visibility when installed on a hinged door 102 and doorframe 106.

FIG. 4 illustrates a top perspective view of the finger protection device 400 in accordance with another preferred embodiment of the present invention. The finger protection device 400 includes attachment units 402 for attaching the first elongated segment 108a to the inner surface of doorframe 106 and the fifth elongated segment 108e to the edge of the hinged door 102. In another embodiment of the present invention, the first elongated segment 108a is attached to the inner edge of the doorframe 106.

Examples of attachment units 402 include but not limited to adhesive, tapes, velcro, screws, or nails. However, it will be readily apparent to those skilled in the art that various other attachment units 402 may also be used without deviating from the scope of the present invention. In a preferred embodiment of the present invention, the elongated segments 108 are rectangular in shape. However it will be readily apparent to those skilled in the art that various other shapes of the elongated segments 108 may be envisioned without deviating from the scope of the present invention.

The present invention offers various advantages such as, the finger protection device covers the space created between the hinged door and the doorframe. The covering of the space protects fingers of persons from getting impinged in the space between the hinged door and the doorframe, during the closing of the hinged door.

There has thus been shown and described a finger protection device that fulfills all the objects and advantages sought therefore. Many changes, modifications, variations and other uses and applications of the subject invention will however, become apparent to those skilled in the art after considering this specification and the accompanying drawings, which disclose the preferred embodiments thereof. All such changes, modifications, variations and other uses and applications, which do not depart from the spirit and scope of the invention, are deemed to be covered by the invention, which is to be limited only by the claims that follow.

1. A finger protection device configured to be mounted on the hinge-side of a hinged door for covering the space created in between the hinged door and the doorframe when the hinged door is opened, the finger protecting device comprising:
five elongated segments sequentially pivotally attached to one another along their long edges;
wherein the first elongated segment attached to the inner edge of the doorframe and the fifth elongated segment attached to the edge of the hinged door;
wherein the length in combination of the first elongated segment and the second elongated segment configured to match the length in combination of the third elongated segment and the fourth elongated segment, so as to force each of the elongated segments to fold until they lie flat against one another and further lie flat against the front face of the door, when the hinged door is closed.

2. The finger protection device according to claim 1 wherein each of the five elongated segments is made up of one of rubber, plastic, polymer, metal, or elastomer.

3. The finger protection device according to claim 1 further comprising attachment units for attaching the first elongated segment with the edge of the hinged door and the fifth elongated segment with the inner edge of the doorframe.

4. The finger protection device according to claim 1 wherein each of the five elongated segments is transparent so as to decrease their visibility.

5. The finger protection device according to claim 1 wherein each of the five elongated segments is made up of thermoplastic elastomer.

6. The finger protection device according to claim 1 further comprising a sixth elongated segment sequentially pivotally attached to the first elongated segment from the long edges, further the sixth elongated segment mounted on the inner surface of the doorframe for providing stability to the remaining elongated segments when the hinged door is opened.
